(19) United States
(12) Patent Application Publication
(10) Pub. No.: US 2016/0253287 A1
(43) Pub. Date: Sep. 1, 2016

(54) INFORMATION PROCESSING DEVICE, INFORMATION PROCESSING METHOD, AND RECORDING MEDIUM

(71) Applicant: NEC CORPORATION, Minato-ku, Tokyo (JP)

(72) Inventors: Junpei KAMIMURA, Tokyo (JP); Takehiko KASHIWAGI, Tokyo (JP)

(21) Appl. No.: 15/030,473

(22) PCT Filed: Jun. 6, 2014
(86) PCT No.: PCT/JP2014/065117

§ 371 Date: Apr. 19, 2016

(30) Foreign Application Priority Data
Oct. 24, 2013 (JP) 2013-221305

(51) Int. Cl. G06F 15/76; G06F 3/06

(52) U.S. Cl. CPC G06F 15/76; G06F 3/0619; G06F 3/0659; G06F 3/0673

(57) ABSTRACT

Provided is an information processing device, comprising: a storage unit which retains a plurality of instances of attribute data included in a tuple as a plurality of tables differing for each attribute; a sequence determination unit which segments a first process which inserts a plurality of tuples into the plurality of tables into a plurality of second processes in units of attributes, and determines a processing sequence of the plurality of second processes after the segmenting; and a pipeline processing unit which executes the plurality of second processes according to the determined processing sequence in a pipeline protocol. This configuration accelerates a process of storing in tables a plurality of instances of tuple data formed from complex attributes, while ensuring isolation.

### TECHNICAL FIELD

1. Description Regarding Related Application

The present invention is based on and claims the priority from Japanese Patent Application No. 2013-221305 (filed on Oct. 24, 2013), the entire description of which the application is incorporated herein by reference.

The present invention relates to an information processing device, an information processing method, and a program and relates particularly to an information processing device, an information processing method, and a program for storing tuples in a column-oriented database.

2. Background Art

Recently, there is a demand for a technique for analyzing in real-time a large volume of data which changes every moment, such as position information. As such, high data insertion performance is desired in addition to high speed reference performance regarding a database.

When high speed reference performance is desired, a column-oriented database is used. The column-oriented database stores segmented data by each attribute (column) which enables high Input/Output (IO) efficiency and allows high speed reference query execution (NPL 1).

As a related technique, PTL 1 describes a shared data processing system which prevents, in accesses from a plurality of systems to shared data in a shared storage device, a situation where only one of the systems is exclusively allowed to access the data and which does not require any exclusive control, such as lock application. PTL 2 describes a processing system including a plurality of memory sharing processors configured to execute jobs in parallel and a means for ensuring data consistency.

### CITATION LIST

### Patent Literature

PTL 1: Japanese Patent Application Laid-open Publication No. Hei 08-235046
PTL 2: Japanese Patent Application Laid-open Publication (Translation of PCT Application) No. 2002-530738
NPL 1: Stonebraker, Mike, et al., “C-Store: A Column-oriented DBMS,” Proceedings of the 31st VLDB Conference, Trondheim, Norway (2005).

### SUMMARY OF INVENTION

### Technical Problem

The entire contents disclosed in PTLs and NPL listed above are incorporated herein by reference. The following analysis was made by the inventors of the present invention.

For real-time data analysis of data being generated in a large volume, it is required that data is stored at high speed. As such, needed is a technique for reducing processing time by carrying out data storing processes in parallel by the use of computational resources, such as a multicore Central Processing Unit (CPU) or a plurality of computers. However, even when data storing processes are carried out in parallel, each instance of data needs to be stored in the database so that it may be pulled in a complete form. Out of the ACID (Atomicity, Consistency, Isolation, Durability) attributes which comprise a database transaction, this property is called “Isolation (I)”.

Description is given below of a method of managing data in the column-oriented database based on a specific example. First, description is given of tabular data with reference to FIG. 11 and FIG. 12. The tabular data in FIG. 11 has three columns (attributes), i.e., ColA, ColB, and ColC. The tabular data in FIG. 11 also has three or more tuples (rows). In addition, for the purpose of illustration, a Tuple Identifier (TID) is set in the tabular data in FIG. 11 in order to uniquely identify the tuple (row).

In the column-oriented database, the tuples each formed by N columns (N attributes) are segmented and managed by each M (≦N) columns. FIG. 12 presents, as an example, a case of tuples segmented and managed by each single column. Managing data by each column in bulk enables data operations for different columns to be carried out simultaneously in parallel, consequently improving the process performance using computational resources, such as a multicore CPU or the plurality of computers.

Description is given of a problem which may occur when two new instances of tuple data, i.e., (Tuple 1)={MS-05, 1981, 3000} and (Tuple 2)={MS-09, 1982, 2000} are to be stored in the column-oriented database configured to manage data as described above with reference to FIG. 11 and FIG. 12.

A first conceivable method is to perform exclusive control on processes among the tuples. An example is a method of storing the data of Tuple 2 after the completion of storing the data of Tuple 1. The storing process for a single tuple is equivalent to the storing process of three columns.

When processes for respective columns are carried out in successive order in the first method, processes which may be carried out simultaneously is the storing process for a single column, and hence it becomes difficult to improve the performance by the use of computational resources, such as the multicore CPU or the plurality of computers.

On the other hand, when the instances of data of columns are processed in parallel in the first method, the following problem occurs. The following procedure is carried out when exclusive control is performed on the processes among the respective tuples and the processes between the columns in the tuples are carried out in parallel: (1) acquire a lock; (2) carry out processes for respective columns in parallel; (3) wait for the completion of the processes for all the columns; and (4) remove the lock. In (3) of the above procedure, the processes are synchronized which increases the calculation cost and makes it difficult to achieve high efficiency of parallel execution. Especially when a program of the storing processes for the columns is performed by different processes or by different computers, the cost for synchronization of the processes further increase.

As described above, the first method, in which exclusive control is performed on the processes among the tuples, has the problem of not being able to improve the performance by the use of adequate computation resources, such as the multicore CPU or the plurality of computers.

A second conceivable method is to execute processes among columns in parallel without performing exclusive control among the tuples. However, according to the second method, it may have a problem of inconsistency with a processing sequence of instances of tuple data among the columns. For example, when the instances of data of Tuple 1 and Tuple 2 are stored in this order for ColA while the instances of data of Tuple 2 and Tuple 1 are stored in this order for ColB, the instances of data are stored as mixed tuples as the values of Tuple 1 and Tuple 2 are mixed, and therefore, it is difficult to ensure isolation of the data processes.

Note that the above-described problems are not solved even with the techniques described in PTLs 1 and 2.

To address these problems, there is a demand for accelerating processes of storing the plurality of instances of tuple data in tables, each tuple data including complex attributes while ensuring isolation. The present invention aims to provide an information processing device, an information processing method, and a program to contribute to the demand.

### Solution to Problem

An information processing device according to a first aspect of the present invention includes:

a storage unit which stores a plurality of instances of attribute data included in a tuple as a plurality of tables differing for each attribute;

a sequence determination unit which segments a first process of inserting a plurality of tuples into the plurality of tables, into a plurality of second processes in a unit of attribute, and determines a processing sequence of the plurality of second processes; and

a pipeline processing unit which carries out the plurality of second processes in pipelining according to the processing sequence.

An information processing method according to a second aspect of the present invention by an information processing device, the information processing method includes:

a step of storing, in a storage unit, a plurality of instances of attribute data included in a tuple as a plurality of tables differing for each attribute;

a step of segmenting a first process of inserting a plurality of tuples into the plurality of tables into a plurality of second processes in a unit of attribute;

a step of determining a processing sequence of the plurality of second processes; and

a step of carrying out the plurality of second processes in pipelining according to the processing sequence.

A program according to the third aspect of the present invention causes a computer to implement processes of, by an information processing device:

storing, in a storage unit, a plurality of instances of attribute data included in a tuple as a plurality of tables differing for each attribute;

segmenting a first process of inserting a plurality of tuples into the plurality of tables into a plurality of second processes in a unit of attribute;

determining a processing sequence of the plurality of second processes; and

carrying out the plurality of second processes in pipelining according to the processing sequence.

Note that the program may be provided as a program product being a non-transitory computer-readable storage medium in which the program is stored.

### Advantageous Effects of Invention

With the information processing device, the information processing method, and the program according to the present invention, it is possible to accelerate processes of storing the plurality of instances of tuple data in tables, each tuple data including complex attributes while ensuring isolation.

### BRIEF DESCRIPTION OF DRAWINGS

FIG. 1 is a block diagram illustrating, as an example, a configuration of an information processing device according to an exemplary embodiment.

FIG. 2 is a block diagram illustrating, as an example, a configuration of an information processing device in a first exemplary embodiment.

FIG. 3 is a flowchart illustrating, as an example, preparation for a pipeline process in the information processing device in the first exemplary embodiment.

FIG. 4 is a flowchart illustrating, as an example, operation of a stage execution unit in the information processing device in the first exemplary embodiment.

FIG. 5 is a block diagram illustrating, as an example, a configuration of an information processing device in a second exemplary embodiment.

FIG. 6 is a flowchart illustrating, as an example, operation of a stage execution unit in the information processing device in the second exemplary embodiment.

FIG. 7 is a flowchart illustrating, as an example, operation of a data reference unit in the information processing device in the second exemplary embodiment.

FIG. 8 is a diagram illustrating, as an example, a configuration of a user interface of an information processing device according to a third exemplary embodiment.

FIG. 9 is a flowchart illustrating, as an example, operation of the information processing device according to the third exemplary embodiment.

FIG. 10 is a block diagram illustrating, as an example, a configuration of an information processing device in a fourth exemplary embodiment.

FIG. 11 is a diagram illustrating an example of a table stored in a database.

FIG. 12 is a diagram illustrating an example of storing data by each attribute (column).

### DESCRIPTION OF EMBODIMENTS

First, an outline of exemplary embodiments is described. Note that the reference signs from the drawings included in this outline are provided solely for illustrative purpose to aid the understanding and are not intended to limit the present invention to any mode illustrated in the drawings.

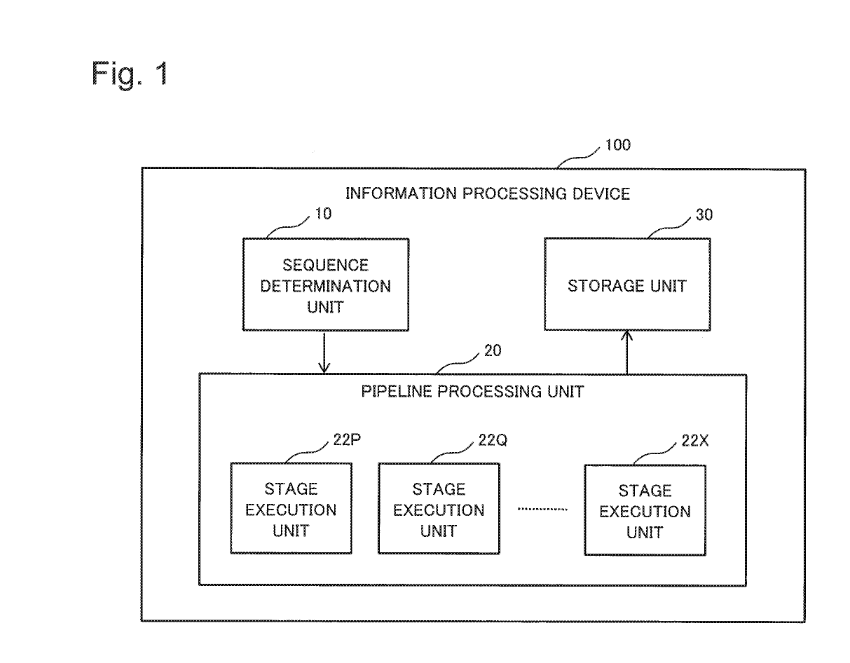

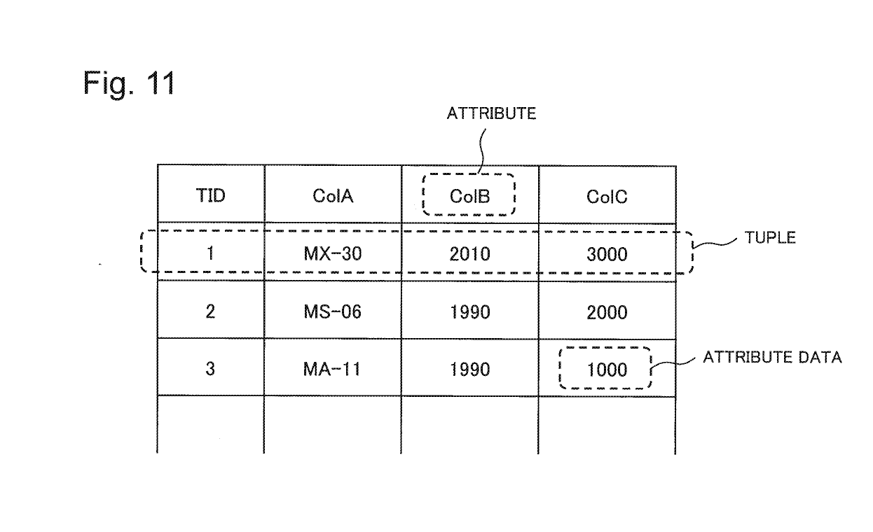

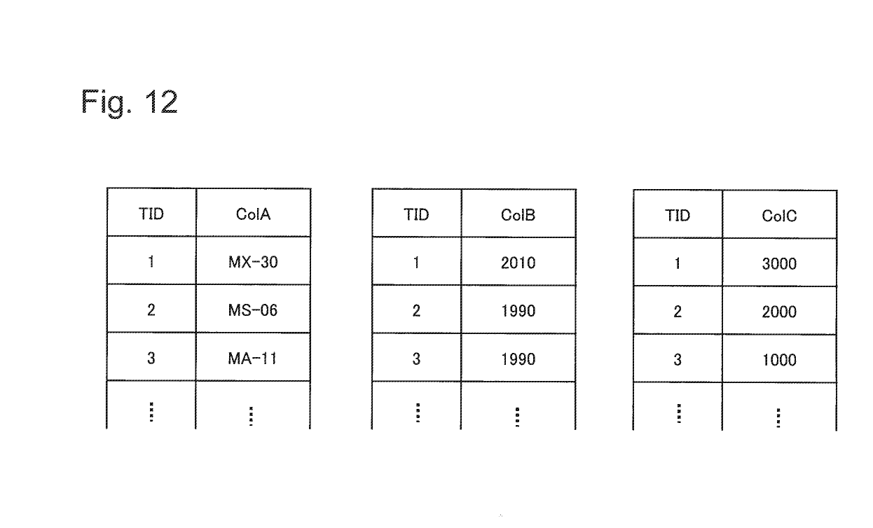

FIG. 1 is a block diagram illustrating, as an example, a configuration of an information processing device 100 according to the exemplary embodiment. According to FIG. 1, the information processing device 100 includes a storage unit 30, a sequence determination unit 10, and a pipeline processing unit 20. The storage unit 30 stores the plurality of instances of attribute data included in a tuple as the plurality of tables differing for each attribute (refer to FIG. 11 and FIG. 12). The sequence determination unit 10 segments a first process of inserting the plurality of tuples into the plurality of tables into a plurality of second processes in a unit of attribute and determines a processing sequence of the plurality of second processes after segmentation. The pipeline processing unit 20 carries out the plurality of second processes according to the determined processing sequence in pipelining.

In the example presented in FIG. 11 and FIG. 12, the first process corresponds to the process of inserting three tuples having TID=1, 2, 3 into three tables presented in FIG. 12. The plurality of second processes correspond to the following three processes: the process of inserting the instances of attribute data {MX-30, MS-06, MA-11} of an attribute “ColA” into the table on the left in FIG. 12 (referred to as “process P”); the process of inserting the instances of attribute data {2010, 1990, 1990} of an attribute “ColB” into the table in the middle in FIG. 12 (referred to as “process Q”); and the process of inserting the instances of attribute data {3000, 2000, 1000} of an attribute “ColC” into the table on the right in FIG. 12 (referred to as “process R”). Note that the present invention is not limited to the case of assigning a single attribute to a single second process and may be employed in the case of assigning the plurality of attributes to a single second process.

Here, the pipeline processing unit 20 may include a plurality of stage execution units 22P, 22Q, . . . , and 22X configured to execute the plurality of second processes in pipelining and the sequence determination unit 10 may assign the plurality of second processes to the plurality of stage execution units 22P, 22Q, . . . , and 22X according to the determined processing sequence. In this case, the plurality of stage execution units 22P, 22Q, . . . , and 22X execute the process assigned among the plurality of second processes, in the same sequence of the plurality of tuples.

In the example in FIG. 11 and FIG. 12, three stage execution units 22P, 22Q, and 22R are used. As an example, the sequence determination unit 10 may assign the process P, the process Q, and the process R to the respective stage execution units 22P, 22Q, and 22R. In this case, the stage execution units 22P, 22Q, and 22R carries out the assigned process P, the process Q, and the process R, respectively, in the same sequence of the plurality of tuples (e.g., the sequence of TID=1, 2, 3). Note that the number of the second processes assigned to a single stage execution unit is not limited to one and the plurality of second processes may be assigned to a single stage execution unit.

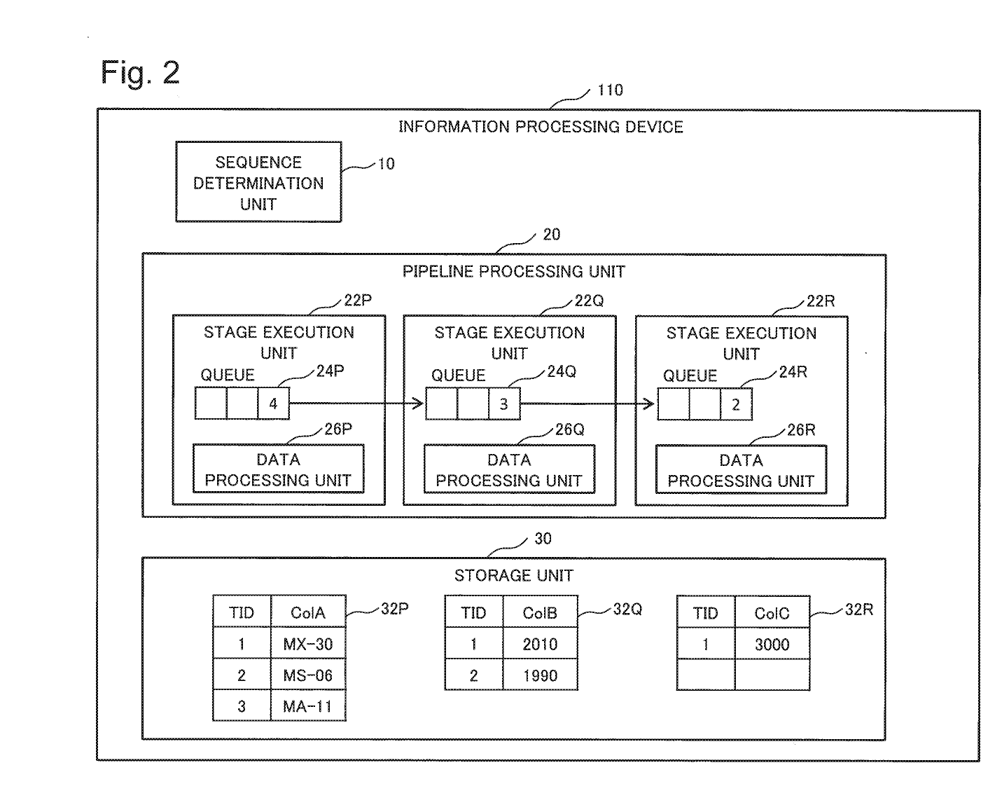

FIG. 2 is a block diagram illustrating a detailed configuration of the pipeline processing unit 20. According to FIG. 2, the stage execution units 22P, 22Q, and 22R preferably include the queues 24P, 24Q, and 24R being configured to retain identifiers identifying the tuples, the data processing units 26P, 26Q, and 26R being configured to insert the instance of attribute data included in the tuple indicated by an identifier dequeued from the corresponding queues 24P, 24Q, and 24R, into the corresponding one of plurality of tables. In this case, when dequeuing of an identifier from the queue 24P (24Q), the data processing unit 26P (26Q) enqueues the dequeued identifier to the queue 24Q (24R) included in the subsequent stage execution unit 22Q (22R).

With the information processing device it is possible to accelerate the process of storing the plurality of instances of tuple data in tables, each tuple data including complex attributes while ensuring isolation.

### Exemplary Embodiment 1

Next, an information processing device according to a first exemplary embodiment is described in detail with reference to the drawings. In this exemplary embodiment, the information processing device stores tuples including a plurality of attributes by each attribute in bulk.

FIG. 2 is a block diagram illustrating, as an example, a configuration of an information processing device 110 of this exemplary embodiment. According to FIG. 2, the information processing device 110 includes a sequence determination unit 10, a pipeline processing unit 20, and a storage unit 30.

The pipeline processing unit 20 includes a plurality of stage execution units 22P, 22Q, and 22R. The stage execution units 22P, 22Q, and 22R include first-in-first-out (FIFO) type queues 24P, 24Q, and 24R each of which is configured to store processes and data processing units 26P, 26Q, and 26R, respectively.

The data processing unit 26P of the stage execution unit 22P carries out the process extracted (dequeued) from the queue 24P and adds (enqueues) the process to the queue 24Q of the subsequent stage execution unit 22Q. Similarly, the data processing unit 26Q of the stage execution unit 22Q carries out the process extracted from the queue 24Q and adds the process to the queue 24R of the subsequent stage execution unit 22R.

The storage unit 30 stores the instances of data for each column (attribute) in bulk.

Note that although the storage unit 30 is configured to manage the instances of data for each column in bulk in this exemplary embodiment, the present invention is not limited to this. For example, the storage unit 30 may be configured to manage the instances of data for each of plurality of columns. The number of columns may differ among the tables stored in the storage unit 30. Furthermore, as an example, although the number of stage execution units is three, i.e., the stage execution units 22P, 22Q, and 22R in this exemplary embodiment, the present invention is not limited to this.

[Operation]

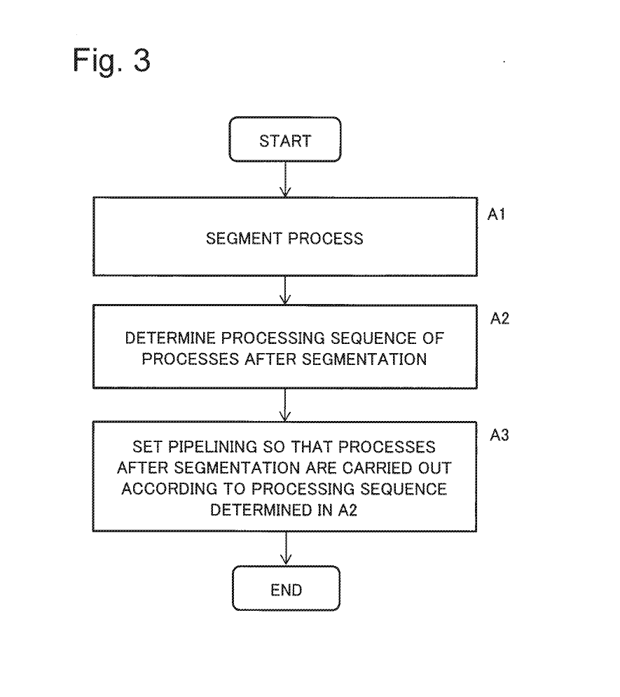

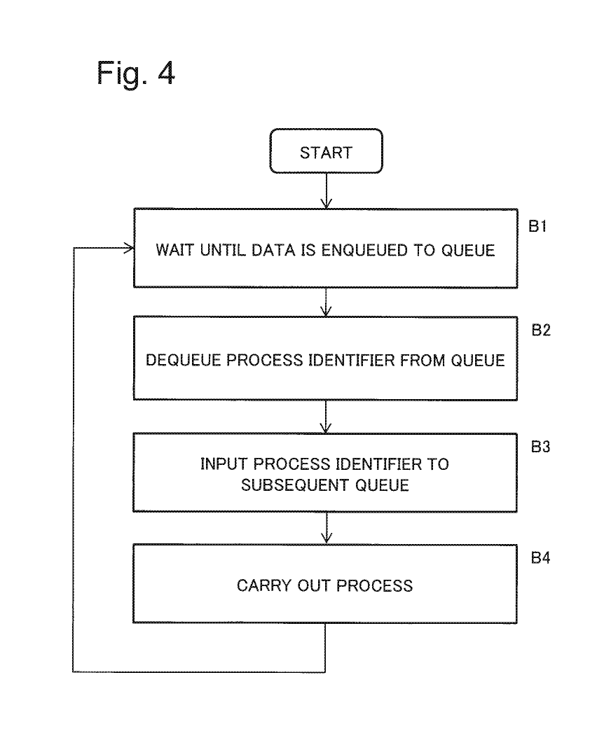

FIG. 3 and FIG. 4 are flowcharts illustrating, as an example, operation of the information processing device 110 (FIG. 2) according to this exemplary embodiment. With reference to FIG. 2 to FIG. 4, description is given of operation for storing the instances of tuple data each including the plurality of attributes illustrated in FIG. 11 in the information processing device 110 with the state of no data. Although the instances of tuple data corresponding to the Tuple Identifiers TID=1, 2, 3 are illustrated in FIG. 11, it is assumed in the following example that the tuples having the Tuple Identifiers TID=1, 2, 3, 4 are to be stored. To store the tuples, it is necessary to prevent the instances of data corresponding to the different Tuple Identifiers from being mixed in order to ensure isolation of the processes.

<Preparation for Pipeline Process>

Preparation for a pipeline process is described with reference to FIG. 3. First, the sequence determination unit 10 segments the tuple data storing process into a plurality of stages (Step A1). Here, as an example, assume a case where the storing of the tuples including three columns is segmented into three stages by column. The process in each stage corresponds to the process of storing instances of data of a single column in a corresponding one of data areas for respective columns in the storage unit 30.

Next, the sequence determination unit 10 determines a sequence in which the stages are to be executed (Step A2). Here, as an example, the processing sequence of the stages is assumed to be ColA, ColB, and then ColC.

Next, the sequence determination unit 10 sets the processes of the stages in the pipeline processing unit 20 (Step A3). Here, the three stage execution units 22P, 22Q, and 22R are provided for the three respective stages. The stage execution units 22P, 22Q, and 22R execute the processes of storing ColA, ColB, and ColC, respectively. Preceding data processing unit sets information on the subsequent queue so that the subsequent process is carried out after the completion of the process by each stage execution unit.

<Tuple Storing Process>

Next, a state of storing data in actual is described with reference to FIG. 2 and FIG. 4. First, a process identifier is stored in the queue 24P of the stage execution unit 22P (Step B1). In this case, the process identifier indicates as the storing process for ColA and specifies a processing target instance of tuple data. It is assumed, in this exemplary embodiment, that the TID, which is the identifier of a storing target tuple, is used as the process identifier, and that the TIDs are stored in ascending order. Note that the storing sequence of the tuples in this exemplary embodiment is merely an example and the present invention is not limited to this.

Each of the stage execution units 22P, 22Q, and 22R operates according to the flowchart in FIG. 4. The data processing unit 26P of the stage execution unit 22P extracts TID=1 from the queue 24P (Step B2) and stores the extracted data in the queue 24Q of the subsequent stage execution unit 22Q (Step B3). Then, the data processing unit 26P stores the data “MX-30” of ColA of the tuple of TID=1, in an area 32P of ColA in the storage unit 30 (Step B4).

Note that the execution sequence of Step B3 and Step B4 in FIG. 4 may be reversed.

Then, the data processing unit 26P of the stage execution unit 22P starts the storing process for the instance of tuple data of TID=2. In parallel with the start of the process for the instance of the tuple data corresponding to TID=2 of the stage execution unit 22P, the data processing unit 26Q of the stage execution unit 22Q extracts TID=1 from the queue 24Q (Step B2) and stores TID=1 in the queue 24R of the subsequent stage execution unit 22R (Step B3). Then, the data processing unit 26Q stores the data “2010” corresponding to ColB of the tuple of TID=1 in an area 32Q of ColB in the storage unit 30 (Step B4).

A similar process is carried out also in the stage execution unit 22R, and the storing processes for the respective columns are carried out simultaneously in parallel.

FIG. 2 illustrates a state where the stage execution unit 22P has completed the above process up to TID=3. In the state illustrated in FIG. 2, the data processing units 26P, 26Q, and 26R execute the respective processes of TID=4, 3, 2. In this way, the insertion processes for the plurality of tuples may be carried out in parallel with the pipeline processing unit.

As the processes for the respective columns retain the first insertion sequence in the queue 24P, isolation of the processes is ensured.

As described above, with the information processing device 110 of this exemplary embodiment, it is possible to execute processes in parallel without losing data integrity and accelerating the data storing process when the data including the plurality of attributes is segmented and stored for each of one or more attributes.

### Exemplary Embodiment 2

Next, an information processing device according to a second exemplary embodiment is described with reference to the drawings. In this exemplary embodiment, as the above, the information processing device stores tuples including the plurality of attributes by each attribute in bulk.

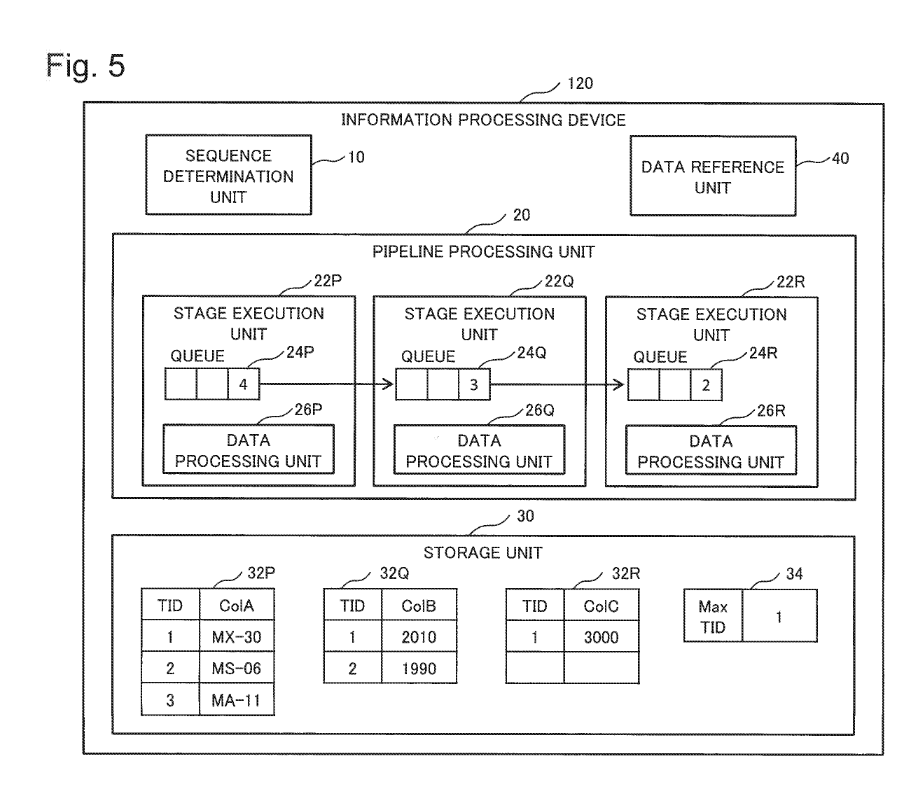

FIG. 5 is a block diagram illustrating, as an example, a configuration of an information processing device 120 of this exemplary embodiment. According to FIG. 5, the information processing device 120 is different from the information processing device 110 (FIG. 2) of the first exemplary embodiment in that the device further includes a data reference unit 40 configured to target process the tuple(s) of which the storing process has been completed, and that the storage unit 30 includes an area 34 which retains the TID of the tuple of which the storing process has been completed.

[Operation]

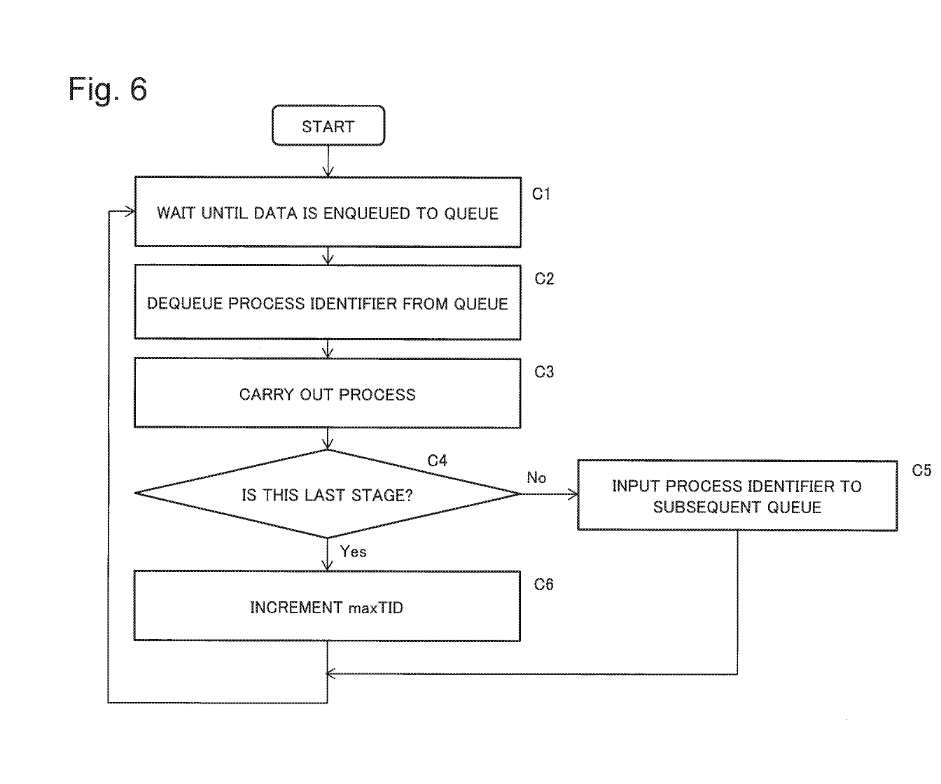

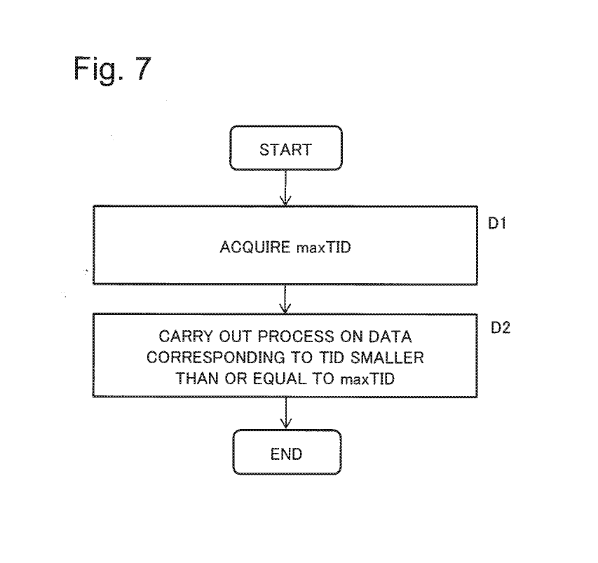

FIG. 6 and FIG. 7 are flowcharts illustrating, as an example, operation of the information processing device 120 of this exemplary embodiment. With reference to FIG. 5 to FIG. 7, description is given of operation of storing instances of the tuple data each including the plurality of attributes illustrated in FIG. 11 in the information processing device 120 with the state of no data. FIG. 11 illustrates the instances of tuple data corresponding to the Tuple Identifiers TID=1, 2, 3. It is assumed below that the tuples having the Tuple Identifiers TID=1, 2, 3, 4 are to be stored. When tuple storing, it is necessary to prevent the instances of data corresponding to the different Tuple Identifiers from being mixed in order to ensure isolation of the processes.

<Preparation of Pipeline Process>

Preparation of a pipeline process is similar to that of the information processing device 110 according to the first exemplary embodiment, and hence the description thereof is omitted.

<Tuple Storing Process>

The operation of storing actual data is described with reference to FIG. 6. First, a process identifier is stored in the queue 24P of the stage execution unit 22P (Step C1). In this case, the process identifier indicates the storing process for ColA and specifies the processing target instance of tuple data. In this exemplary embodiment, the TID is used as the process identifier which is the identifier of a storing target tuple and the TIDs are stored in ascending order. Note that the storing sequence of the tuples in this exemplary embodiment is merely an example, and the present invention is not limited to this.

Each of the stage execution units 22P, 22Q, and 22R operates according to the flowchart in FIG. 6. The data processing unit 26P of the stage execution unit 22P extracts TID=1 from the queue 24P (Step C2), and the data processing unit 26P stores the data “MX-30” corresponding to ColA of the tuple of TID=1, in an area 32P of ColA in the storage unit 30 (Step C3).

Then, since this is not the last stage (No in Step C4), the data processing unit 26P stores TID=1 in the queue 24Q of the subsequent stage execution unit 22Q (Step C5). The data processing unit 26P of the stage execution unit 22P then starts the storing process for the instance of the data of the tuple of TID=2.

In parallel with the start of the tuple data process of TID=2 of the stage execution unit 22P, the data processing unit 26Q of the stage execution unit 22Q extracts TID=1 from the queue 24Q (Step C2) and stores the data “2010” corresponding to ColB of the tuple of TID=1, in an area 32Q of ColB in the storage unit 30 (Step C3).

Then, since this is not the last stage (No in Step C4), the data processing unit 26Q stores TID=1 in the queue 24R of the subsequent stage execution unit 22R (Step C5).

Similarly, in parallel with the start for the instance of the tuple data corresponding to TID=2 of the stage execution unit 22Q, the data processing unit 26R of the stage execution unit 22R extracts TID=1 from the queue 24R (Step C2) and stores the data “3000” corresponding to ColC of the tuple of TID=1, in an area 32R of ColC in the storage unit 30 (Step C3).

Then, since this is the last stage for processing the instances of tuple data (Yes in Step C4), the data processing unit 26R updates (e.g., increments) a value MaxTID of an area 34 which stores MaxTID in the storage unit 30 (Step C6).

FIG. 5 illustrates a state where the above process is completed up to TID=3 in the stage execution unit 22P.

According to the information processing device 120 of this exemplary embodiment, as the information processing device 110 of the first exemplary embodiment, it is possible to execute the processes of storing the tuples in parallel while ensuring isolation of the tuple processes. In addition, according to this exemplary embodiment, it is possible to keep track of the TID of the tuples up to which the tuple insertion process has been completed by referring to the value MaxTID in the storage unit 30.

In this exemplary embodiment, description is given of the case where the TIDs assigned to the instances of input data in FIG. 11 are the same as the TIDs after the storing in FIG. 5, however, the present invention is not limited to this. The TIDs after storing may be any serial tuple management identifier assigned per the input sequence of the pipeline processing unit and the MaxTID may be any tuple management identifier currently stored.

<Tuple Reference Process>

Next, a process of referring to data in the state in FIG. 5 is described with reference to FIG. 7. Here, description is given, as an example of a reference process, of a process of acquiring the value corresponding to the attribute “ColA” of the tuple having a value of ColB being smaller than or equal to 2013.

First, the data reference unit 40 refers to the area 34 which stores the value MaxTID in the storage unit 30 and acquires the value stored in the area (Step D1). Here, the data reference unit 40 acquires MaxTID=1.

The data reference unit 40 then searches for the tuple having a value of ColB which is smaller than or equal to 2013 in the range of TID≦1 (Step D2). Here, as a result of this search, the data reference unit 40 acquires TID={1}. The data reference unit 40 returns the value “MX-30” of ColA of TID={1} as the result.

With the information processing device 120 of this exemplary embodiment, which carries out the reference process using MaxTID as described above, it is possible to execute the reference process only for the tuple(s) for which the storing process has been completed at the time of starting the reference process.

### Exemplary Embodiment 3

Next, an information processing device according to a third exemplary embodiment is described with reference to the drawings.

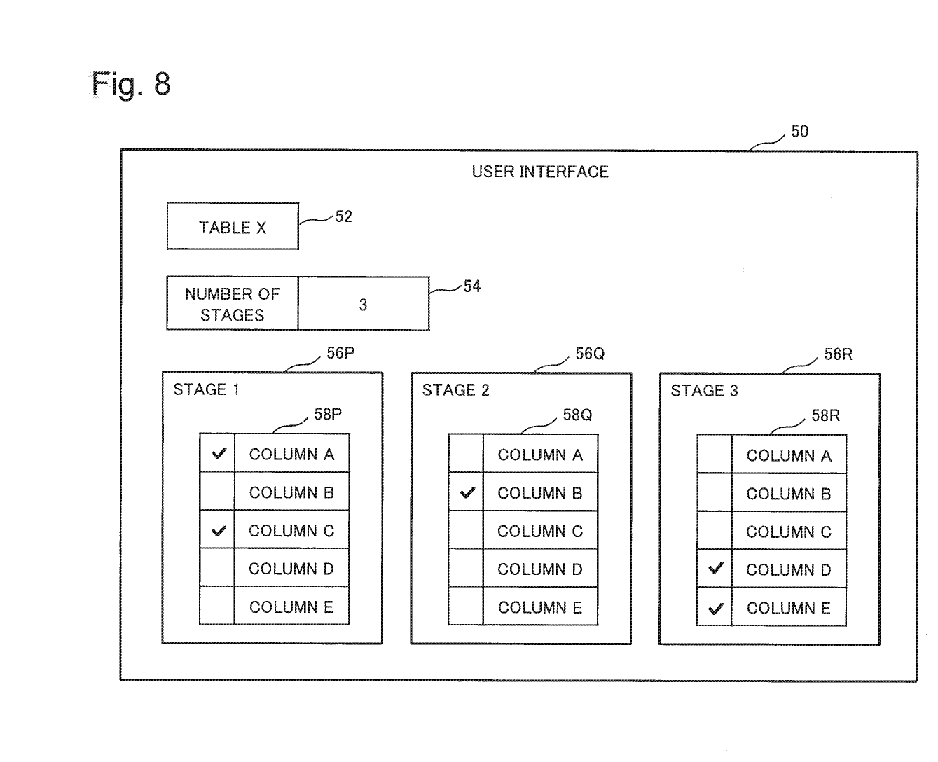

The information processing device of this exemplary embodiment further includes a user interface 50 illustrated in FIG. 8 in addition to the information processing device 110 (FIG. 2) of the first exemplary embodiment or the information processing device 120 (FIG. 5) of the second exemplary embodiment. A user of the information processing device sets a parameter specifying operation to be performed by the sequence determination unit 10, via the user interface 50. Based on the information input to the user interface 50 by the user, the sequence determination unit 10 determines which processes to be performed in Steps A1 and A2 in FIG. 3.

According to FIG. 8, the user interface 50 includes an area 52 which specifies a table, an area 54 to which the number of stages is input (i.e., the number of segments obtained by segmenting, in a column direction, the process of inserting the plurality of tuples in tables), an area 56P, 56Q, and 56R which indicates the respective stages, and an area 58P, 58Q, and 58R which selects the columns to be processed at the corresponding stage.

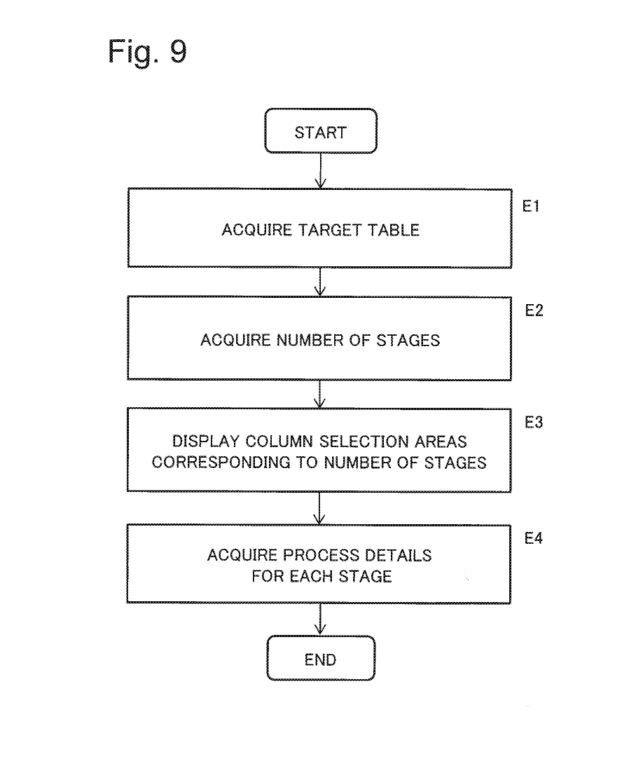

Operation of the user interface 50 in FIG. 8 is described with reference to the flowchart in FIG. 9. First, the user inputs a table name to a specified table in the area 52. Note that the user may select the processing target table name from provided table names. The sequence determination unit 10 acquires a target table according to the table name input in the area 52 (Step E1).

The user then inputs the number of stages in the area 54, to which the number of stages is input. The sequence determination unit 10 acquires the number of stages input in the area 54 (Step E2).

The user interface 50 then displays the column selection areas 56P, 56Q, and 56R corresponding to the number of stages input in the area 54 (Step E3). The example in FIG. 8 illustrates a case where the user inputs so that the insertion process for a table X including columns A to E is to be carried out by three-stage pipelining. The user interface 50 displays the areas 58P, 58Q, and 58R which display the columns A to E of the table X, in the areas 56P, 56Q, and 56R which indicate the three stages.

In each of the areas 58P, 58Q, and 58R in which the column(s) to be processed at the corresponding stage is selected, the user marks the column(s) to be processed at the stage. FIG. 8 illustrates a case where the user inputs so that the column A and the column C are processed at a stage 1, the column B is processed at a stage 2, and the column D and the column E are processed at a stage 3. The sequence determination unit 10 acquires process details for each stage based on the inputs by the user (Step E4).

According to the information processing device of this exemplary embodiment, by including the user interface 50 illustrated in FIG. 8, it is possible for the user to set process details for each stage separately.

### Exemplary Embodiment 4

Next, an information processing device according to a fourth exemplary embodiment is described with reference to the drawings.

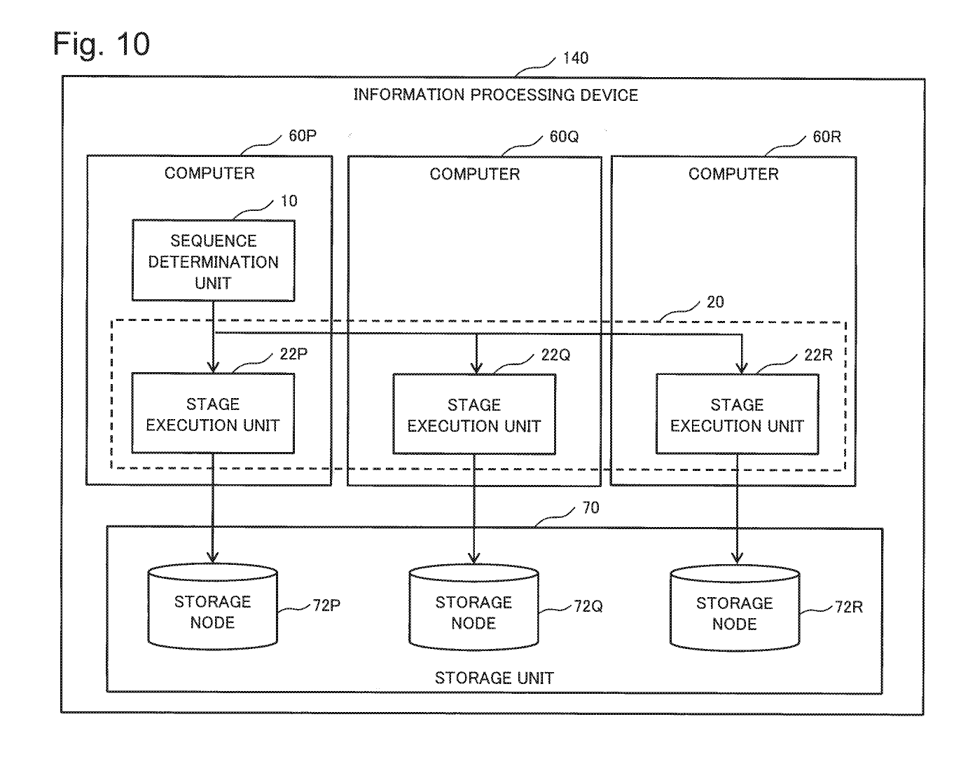

FIG. 10 is a block diagram illustrating, as an example, a configuration of an information processing device 140 of this exemplary embodiment. According to FIG. 10, the information processing device 140 includes computers 60P, 60Q, and 60R, as well as a storage unit 70. The computer 60P includes a sequence determination unit 10 and a stage execution unit 22P. In addition, the computers 60Q and 60R include respective stage execution units 22Q and 22R. The storage unit 70 includes storage nodes 72P, 72Q, and 72R.

Specifically, the information processing device 140 of this exemplary embodiment has a set configuration in which the stage execution units 22P, 22Q, and 22R included in the pipeline processing unit 20 of the information processing device 110 (FIG. 2) of the first exemplary embodiment are distributed to the respective computers 60P, 60Q, and 60R. In addition, the information processing device 140 includes storage nodes 72P, 72Q, and 72R which retain the respective tables of the areas 32P, 32Q, and 32R illustrated in FIG. 2.

The detailed configuration of the stage execution units 22P, 22Q, and 22R and the operation of the sequence determination unit 10 and the stage execution units 22P, 22Q, and 22R of this exemplary embodiment are similar to those of the information processing device (FIG. 2 to FIG. 4) of the first exemplary embodiment, and hence the description thereof is omitted.

According to the information processing device 140 of this exemplary embodiment, it is possible to accelerate the processes of storing in a database the plurality of instances of tuple data based on complex columns (attributes) by the use of the plurality of computers and the plurality of storage nodes, while ensuring isolation.

The invention of the present application is described above with reference to the above exemplary embodiments, however, the invention of the present application is not limited to the above-described exemplary embodiments. It is possible to make various changes which may be understood by those skilled in the art to the configuration and details of the invention of the present application within the scope of the invention of the present application. For example, the stage execution units of the pipeline processing unit and the storage unit do not need to be provided in a single computer and may be virtually or physically distributed to the plurality of computers. In the second exemplary embodiment, the value MaxTID is equal to the processed TID of the last column in the sequence of the column storing processes determined by the sequence determination unit 10. Accordingly, the data reference unit 40 may refer directly to the value of the TID of the last column, instead of providing the area 34 for MaxTID in the storage unit 30.

Note that in the present invention, the following modes are possible.

### [Mode 1]

The information processing device according to the above-described first aspect.

### [Mode 2]

In the information processing device according to Mode 1,

the pipeline processing unit includes a plurality of stage execution units which execute the plurality of second processes in pipelining; and

the sequence determination unit assigns the plurality of second processes to the plurality of stage execution units according to the processing sequence.

### [Mode 3]

In the information processing device according to Mode 2, the plurality of stage execution units execute the assigned process from the plurality of second processes in same sequence for the plurality of tuples.

### [Mode 4]

In the information processing device according to Mode 3, the plurality of stage execution units includes

a queue retaining an identifier identifying the tuple and

a data processing unit inserting an instance of attribute data included in the tuple indicated by the identifier dequeued from the queue, into the corresponding one of the plurality of tables.

### [Mode 5]

In the information processing device according to Mode 4, when dequeuing of the identifier from the queue, the data processing unit enqueues the dequeued identifier to the queue included in the subsequent stage execution unit.

### [Mode 6]

In the information processing device according to any one of Modes 2 to 5, the storage unit stores a count value indicating the number of tuples of the plurality of tuples the last stage execution unit has processed.

### [Mode 7]

In the information processing device according to Mode 6, when dequeuing of the identifier from the queue, the data processing unit included in the last stage execution unit inserts an instance of attribute data included in the tuple indicated by the dequeued identifier, into the corresponding one of the plurality of tables and updates the count value stored in the storage unit.

### [Mode 8]

In the information processing device according to any one of Modes 1 to 7, upon receipt of number of segments to which the first process is to be segmented, the sequence determination unit segments the first process into the plurality of second processes according to the received number of segments.

### [Mode 9]

In the information processing device according to Mode 8, the sequence determination unit receives the assignment of the plurality of attributes included in the plurality of tuples to the plurality of second processes and assigns the plurality of attributes to the plurality of second processes according to the received assignment.

### [Mode 10]

The information processing method according to the above-described second aspect.

### [Mode 11]

The information processing method according to Mode 10, includes a step of assigning the plurality of second processes for a plurality of stage execution units which process the plurality of second processes in pipelining, according to the processing sequence.

### [Mode 12]

In the information processing method according to Mode 11, the plurality of stage execution units execute the assigned process from the plurality of second processes in same sequence for the plurality of tuples.

### [Mode 13]

The information processing method according to Mode 12, includes by the stage execution units;

a step of storing the plurality of an identifier identifying the tuple in a queue and

a step of inserting an instance of attribute data included in the tuple indicated by the identifier dequeued from the queue in the corresponding one of the plurality of tables.

### [Mode 14]

In the information processing method according to Mode 13, when dequeuing of the identifier from the queue, the plurality of stage execution unit enqueues the dequeued identifier to the queue included in a subsequent stage execution unit.

### [Mode 15]

In the information processing method according to any one of Modes 11 to 14, includes a step of storing in the storage unit, a count value indicating the number of tuples of the plurality of tuples the last stage execution unit has processed.

### [Mode 16]

In the information processing method according to Mode 15, when dequeuing of the identifier from the queue, the last stage execution unit inserts an instance of attribute data included in the tuple indicated by the dequeued identifier, into the corresponding one of the plurality of tables and updates the count value stored in the storage unit.

### [Mode 17]

The program according to the above-described third aspect.

### [Mode 18]

The program according to Mode 17, wherein causing the computer to implement a process of assigning the plurality of second processes according to the processing sequence to a plurality of stage execution units which execute the plurality of second processes in pipelining.

### [Mode 19]

The program according to Mode 18, wherein causing the plurality of stage execution units to implement a process of carrying out the assigned one of the plurality of second processes in same sequence for the plurality of tuples.

### [Mode 20]

The program according to Mode 19, wherein causing the plurality of stage execution units to implement processes of:

storing an identifier identifying the tuple, in a queue and

inserting an instance of attribute data included in the tuple indicated by the identifier dequeued from the queue, into the corresponding one of the plurality of tables.

### [Mode 21]

The program according to Mode 20, causing the plurality of stage execution units to implement a process of enqueuing, when dequeuing of the identifier from the queue, the dequeued identifier to the queue included in the subsequent stage execution unit.

Note that the contents of the entire disclosures of PTLs and NPL listed above are incorporated in this description by reference. Changes and adjustments of the exemplary embodiments are further made possible within the entire disclosure of the present invention (including the scope of claims) based on the basic technical spirit. Various combinations of and selections from various disclosed elements (including the elements in the claims, the elements in the exemplary embodiments, the elements in the drawings and the like) are possible within the scope of the claims of the present invention. In other words, the present invention naturally includes various alternations and modifications which may be made by those skilled in the art according to the entire disclosure including the scope of claims and the technical spirit. In particular, each numeric range described in this description should be understood so that any numeric value or smaller range included in the range is specifically described even without being particularly mentioned.

### REFERENCE SIGNS LIST

10 sequence determination unit
20 pipeline processing unit
22P, 22Q, 22R, . . . , 22X stage execution unit
24P, 24Q, 24R queue
26P, 26Q, 26R data processing unit
30, 70 storage unit
32P, 32Q, 32R, 34 area
40 data reference unit
50 user interface
60P, 60Q, 60R computer
72P, 72Q, 72R storage node
52, 54, 56P, 56Q, 56R, 58P, 58Q, 58R area
100, 110, 120, 140 information processing device

What is claimed is:

1. An information processing device comprising:
a storage unit which stores a plurality of instances of attribute data included in a tuple as a plurality of tables differing for each attribute;
a sequence determination unit which segments a first process of inserting a plurality of tuples into the plurality of tables, into a plurality of second processes in a unit of attribute, and determines a processing sequence of the plurality of second processes; and
a pipeline processing unit which carries out the plurality of second processes in pipelining according to the processing sequence.

2. The information processing device according to claim 1, wherein
the pipeline processing unit includes a plurality of stage execution units which execute the plurality of second processes in pipelining; and
the sequence determination unit assigns the plurality of second processes to the plurality of stage execution units according to the processing sequence.

3. The information processing device according to claim 2, wherein the plurality of stage execution units carries out the assigned process from the plurality of second processes in same sequence for the plurality of tuples.

4. The information processing device according to claim 3, wherein the plurality of stage execution units includes
a queue retaining an identifier identifying the tuple and
a data processing unit inserting an instance of attribute data included in the tuple indicated by the identifier dequeued from the queue, into the corresponding one of the plurality of tables.

5. The information processing device according to claim 4, wherein, when dequeuing of the identifier from the queue, the data processing unit enqueues the dequeued identifier to the queue included in the subsequent stage execution unit.

6. The information processing device according to claim 2, wherein the storage unit stores a count value indicating the number of tuples of the plurality of tuples the last stage execution unit has processed.

7. The information processing device according to claim 6, wherein, when dequeuing of the identifier from the queue, the data processing unit included in the last stage execution unit inserts an instance of attribute data included in the tuple indicated by the dequeued identifier, into the corresponding one of the plurality of tables and updates the count value stored in the storage unit.

8. The information processing device according to claim 1, wherein, the sequence determination unit receives number of segments to which the first process is to be segmented and segments the first process into the plurality of second processes according to the received number of segments.

9. The information processing device according to claim 8, wherein the sequence determination unit receives the assignment of the plurality of attributes included in the plurality of tuples to the plurality of second processes and assigns the plurality of attributes to the plurality of second processes according to the received assignment.

10. An information processing method by an information processing device, the information processing method comprising:
storing, in a storage unit, a plurality of instances of attribute data included in a tuple as a plurality of tables differing for each attribute;
segmenting a first process of inserting a plurality of tuples into the plurality of tables into a plurality of second processes in a unit of attribute;
determining a processing sequence of the plurality of second processes; and
carrying out the plurality of second processes in pipelining according to the processing sequence.

11. The information processing method according to claim 10, comprising assigning the plurality of second processes for a plurality of stage execution units which process the plurality of second processes in pipelining, according to the processing sequence.

12. The information processing method according to claim 11, wherein the plurality of stage execution units carries out the assigned process from the plurality of second processes in same sequence for the plurality of tuples.

13. The information processing method according to claim 12, comprising, by the stage execution units,
storing the plurality of an identifier identifying the tuple in a queue, and
inserting an instance of attribute data included in the tuple indicated by the identifier dequeued from the queue, in the corresponding one of the plurality of tables.

14. The information processing method according to claim 13, wherein, when dequeuing of the identifier from the queue, the plurality of stage execution unit enqueues the dequeued identifier to the queue included in a subsequent stage execution unit.

15. The information processing method according to claim 11, comprising,
storing in the storage unit, a count value indicating the number of tuples of the plurality of tuples the last stage execution unit has processed.

16. The information processing method according to claim 15, wherein, when dequeuing of the identifier from the queue, the last stage execution unit inserts an instance of attribute data included in the tuple indicated by the dequeued identifier, into the corresponding one of the plurality of tables and updates the count value stored in the storage unit.

17. A non-transitory computer-readable recording medium storing a program for causing a computer to implement processes of, by an information processing device:
storing, in a storage unit, a plurality of instances of attribute data included in a tuple as a plurality of tables differing for each attribute;
segmenting a first process of inserting a plurality of tuples into the plurality of tables into a plurality of second processes in a unit of attribute;
determining a processing sequence of the plurality of second processes; and
carrying out the plurality of second processes in pipelining according to the processing sequence.

18. The non-transitory computer-readable recording medium according to claim 17, wherein causing the computer to implement a process of assigning the plurality of second processes according to the processing sequence to a plurality of stage execution units which execute the plurality of second processes in pipelining.

19. The non-transitory computer-readable recording medium according to claim 18, wherein causing the plurality of stage execution units to implement a process of carrying out the assigned one of the plurality of second processes in same sequence for the plurality of tuples.

20. The non-transitory computer-readable recording medium according to claim 19, wherein causing the plurality of stage execution units to implement processes of:
storing an identifier identifying the tuple, in a queue and
inserting an instance of attribute data included in the tuple indicated by the identifier dequeued from the queue, into the corresponding one of the plurality of tables.
